(19) United States
(12) Patent Application Publication
(10) Pub. No.: US 2006/0052077 A1
(43) Pub. Date: Mar. 9, 2006

(54) Tunable compensation device and method for received signals

(75) Inventors: Cheng-Kuo Wang, Hsinchu (TW); Yi-Hua Lu, Fengshan City (TW); Ding-Kai Chen, Taichung City (TW)

Correspondence Address: BRUCE H. TROXELL, SUITE 1404, 5205 LEEBURG PIKE, FALLS CHURCH, VA, 22041, US

(73) Assignee: Micro-Star Int' 1. Co., Ltd.

(21) Appl. No.: 10/938,530

(22) Filed: Sep. 13, 2004

(30) Foreign Application Priority Data
Sep. 7, 2004 (TW) 93126933

(51) Int. Cl. H04B 1/16

(52) U.S. Cl. 455/340

(57) ABSTRACT

The present invention relates to a tunable compensation device and method for received signals. The tunable compensation device comprises a first antenna, a compensation device, a second antenna and a signal processing unit. The first antenna receives a first radio wave. The compensation device receives and compensates the first radio wave. The second antenna receives a second radio wave. The signal processing unit receives the compensated first radio wave and the second radio wave as to control the compensation by the compensation unit for the first radio wave. The tunable compensation method is characterized in that the first radio wave received by the first antenna is used to modulate the second radio wave received by the second antenna.

### 1. FIELD OF THE INVENTION

The present invention relates to a device and method for receiving signals, and more particularly, to a tunable compensation device and method for received signals.

### 2. BACKGROUND OF THE INVENTION

A wireless local area network (WLAN) is a local area network (LAN) without wires, which enables users to roam around a building with a laptop equipped with. a wireless LAN card and stay connected to their network through an access point without being connected to a wire. WLAN is a data communication system similar to the conventional Ethenet that is implemented as an extension to, or as an alternative for, a wired LAN for transferring data through radio frequencies instead of cables.

With wireless LANs, users can access shared information without looking for a place to plug in, and network managers can set up or augment networks without installing or moving wires. Wireless LANs offer the following productivity, service, convenience, and cost advantages over traditional wired networks:
(a) Mobility-Wireless LAN systems can provide LAN users with access to real-time information anywhere in their organization. This mobility supports productivity and service opportunities not possible with wired networks.
(b) Installation Speed and Simplicity-Installing a wireless LAN system can be fast and easy and can eliminate the need to pull cable through walls and ceilings.
(c) Installation Flexibility-Wireless technology allows the network to go where wire cannot go.
(d) Reduced Cost-of-Ownership-While the initial investment required for wireless LAN hardware can be higher than the cost of wired LAN hardware, overall installation expenses and life-cycle costs can be significantly lower. Long-term cost benefits are greatest in dynamic environments requiring frequent moves, adds, and changes.
   Therefore, today WLANs are becoming more widely recognized as a general-purpose connectivity alternative for a broad range of business customers.

WLANs have been around for more than a decade, but are just beginning to gain momentum because of falling costs and improved standards. Recently, WLANs are being set up in resorts, apartment buildings and airports, etc. allowing multiple users to access one Internet connection via laptop computer or PDA equipped with wireless LAN card. Often the best use for WLANs are in places where LANs are not installed yet, like schools or public institutions that are slow to adopt new technologies. Starbucks and Microsoft are also getting into the WLAN game. They are teaming up to equip their coffee shops with WLANs, which allow laptop users to surf the Net while sipping lattes

In a typical WLAN configuration, an access point is connected to the wired network from a fixed location using standard Ethernet cable for receiving, buffering, and transmitting data between the WLAN and the wired network infrastructure. On the other hand, end users access the WLAN through wireless LAN adapters, which are implemented as wireless LAN cards in notebook computers, or use ISA or PCI adapters in desktop computers, or fully integrated devices within hand-held computers. In this regard, the quality of wireless transmission is fully dependent on the receiving/transmitting capabilities of the access point and the wireless LAN card. Basically the reception of a packet is affected by three types of interference: channel noise, multipath interference, and multi-user interference. Since the wireless LAN is mostly being implemented indoors, the throughput thereof will be mostly affected by the multipath interference.

Currently, the major methods adopted by a conventional access point/wireless LAN card for solving the multipath interference are antenna diversity and baseband processing, wherein the antenna diversity involves the use of multiple antennas to receive multiple instances of the same signal. However, even when the multipath interference is dealt by the conventional access point/wireless LAN card using methods of antenna diversity and baseband processing, the inter symbol interference caused by the multipath interference still leave much to be improved.

Please refer to FIG. 1, which is a schematic diagram showing a receiver of a conventional access point/wireless LAN card using two antennas for receiving RF signals. As seen in FIG. 1, the receiver 100 simultaneously uses two antennas 110, 120 to receive RF signals, while the base-band processor 1(BBP) 30 controls the switch 140 to select an antenna out of the two antennas 110, 120 as the receiving antenna of the receiver 100 based on the magnitude of signals received by the two antennas 110, 120.

For example, the antenna 110 is used as the default receiving antenna of the receiver 100 first that the RF signals received by the antenna 110 will be fed to the RF front-end 150 for down-converting and then the down-converted signals is fed to the BBP 130 to be adjusted. If the adjust signal can not meet with a specified requirement, the BBP 130 will direct the switch 140 to select the antenna 120 as the receiving antenna of the receiver 100, and similarly, the RF signals received by the antenna 120 will be fed to the RF front-end 150 for down-converting and then the down-converted signals is fed to the BBP 130 to be adjusted. If the adjust signal still can not meet with the specified requirement, the switch 140 will switch back to the antenna 1 10 from the antenna 120.

As the description disclosed above, the access point/wireless LAN card with two antennas as receiving antennas will still suffer the inter symbol interference caused by the multipath interference.

In view of the above description, the present invention relates to a tunable compensation device and method for received signals that is capable of effectively reducing the inter symbol interference caused by the multipath interference while an access point/wireless LAN card is receiving a RF signal.

### SUMMARY OF THE INVENTION

The primary object of the invention is to provide a tunable compensation device and method for received signals, capable of enabling the wireless communication using the same to be free from the multipath interference. To achieve the above object, the tunable compensation device for received signals of the invention comprises a first antenna, a compensation unit, a second antenna, and a signal processing unit, wherein, the first antenna receives a first RF signal and output the same to the compensation unit, and the compensation unit receives the first RF signal from the first antenna and outputs a compensated first RF signal, and the second antenna receives a second RF signal and output the same to the signal processing unit, and the signal processing unit receives signals outputted from both the compensation unit and the second antenna for controlling the compensation unit.

In a preferred embodiment of the invention, the compensation unit is a phase compensator, which is used for adjusting the phase of the first RF signal while outputting the same. In another preferred embodiment, the compensation unit is consisted of a phase compensator and a magnitude compensator, wherein the magnitude compensator receives the first RF signal and then adjusts the magnitude of the same for outputting a magnitude-adjusted first RF signal, and thereafter, the phase compensator receives the magnitude-adjusted first RF signal and then adjust the phase of the same for outputting a compensated RF signal.

The signal processing unit comprises a RF combiner, a RF front-end, and a baseband processor. Wherein, the RF combiner receives both the compensated first RF signal from the compensation unit and the second RF signal from the second antenna for synthesizing the two to output a combined signal; the combined signal is fed to the RF front-end for down-converting and then outputting the down-converted signal; and the down-converted signal is fed to the baseband processor for enabling the baseband processor to output a feedback signal and thus control the compensation unit.

Furthermore, the present invention provides a tunable compensation method for received signals, the method comprising the steps as following: providing a first antenna and a second antenna for receiving RF signals; and adjusting the RF signal received by the second antenna based on the RF signal received by the first antenna.

In a preferred embodiment of the invention, the method further comprises: compensating the phase and magnitude of a RF signal received by the first antenna; combining the compensated RF signal with a RF signal received by the second antenna; and based on the combined signal to feedback control the phase and magnitude compensations of the RF signal received by the first antenna.

Moreover, the combined signal is being down-converted and then the down-converted combined signal is used as base to feedback control the phase and magnitude compensation of the RF signal received by the first antenna.

### BRIEF DESCRIPTION OF THE DRAWINGS

FIG. 1 is a schematic diagram showing a receiver of a conventional access point/wireless LAN card, which uses two antennas for receiving RF signals.

FIG. 2 is a schematic diagram showing the circuit of the tunable compensation device for received signals according to the present invention.

FIG. 3A and FIG. 3B are diagrams respectively illustrating the transaction rate of a conventional wireless device and a wireless device of the present invention.

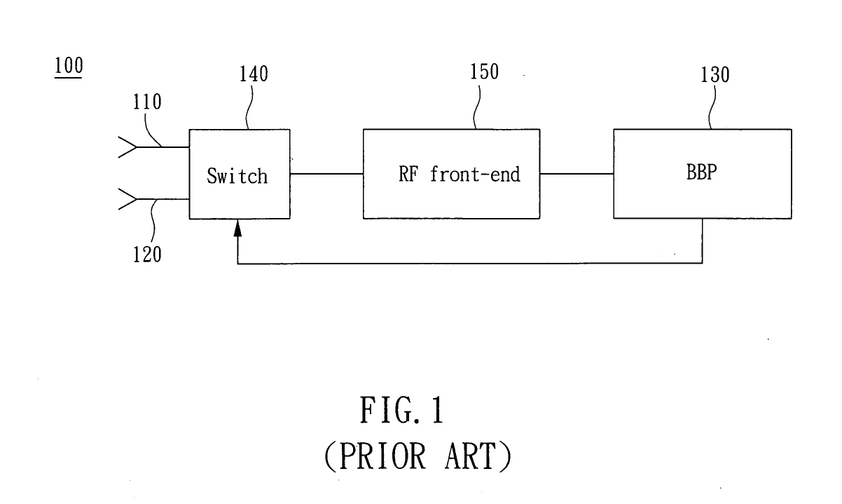

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

As the access point/wireless LAN card using one antenna for receiving RF signals will suffer the inter symbol interference caused by the multipath interference. The present invention provides a receiver having a first and a second antennas for receiving RF signals, wherein the RF signal received by the second antenna is adjusted according to the RF signal received by the first antenna such that the inter symbol interference caused by the multipath interference can be eliminated.

For instance, the RF signal implemented by the access point/wireless LAN card is the combined signal of a phase-magnitude- adjusted RF signal received by the first antenna and a RF signal received by the second antenna. Moreover, a feedback control mechanism is used for controlling the combined signal based on the combined signal itself, the specifications of users and the phase/magnitude of the RF signal received by the first antenna.

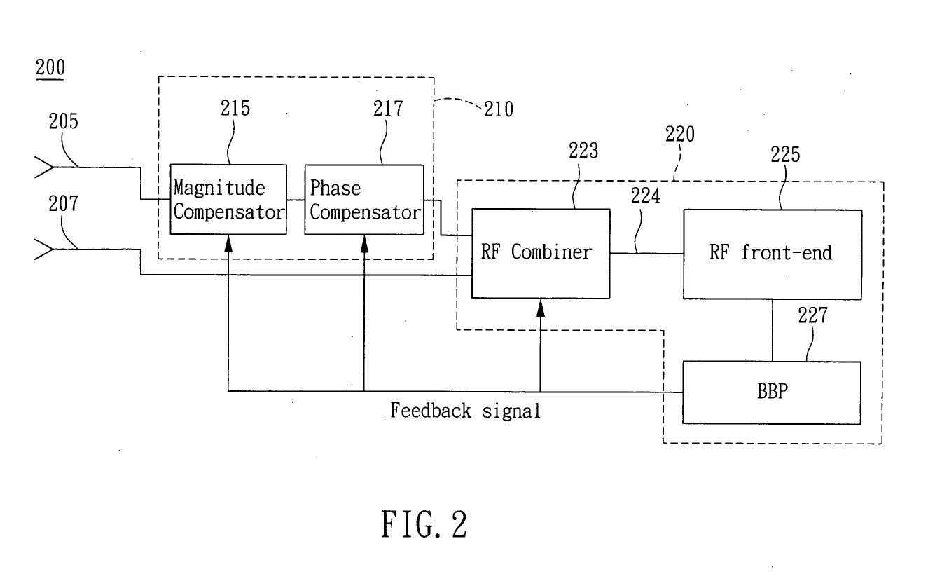

Please refer to FIG. 2, which is a schematic diagram showing the circuit of the tunable compensation device for received signals according to the present invention. As seen in FIG. 2, the tunable compensation device for receiving signals 200 of the invention comprises two antennas 205, 207, a compensation unit 210, and a signal processing unit 220, wherein, the compensation unit receives a RF signal from the antenna 205 and outputs a phase-magnitude-compensated RF signal. In addition, the compensation unit 210 is consisted of a phase compensator 217 and a magnitude compensator 215, and the signal processing unit 220 that is consisted of a RF combiner 223, a RF front-end 225, and a baseband processor 227.

Wherein, the magnitude compensator 215 receives the RF signal from the antenna 205 and then adjusts the magnitude of the same so as to output a magnitude-adjusted RF signal, and thereafter, the magnitude-adjusted RF signal is fed to the phase compensator 207 for adjusting the phase of the same so as to output a compensated RF signal, furthermore, the RF combiner 223 is used for receiving both the compensated RF signal from the compensation unit 210 and the RF signal from the antenna 207 for synthesizing the two to output a combined signal 224; and the combined signal 224 is then being fed to the RF front-end 225 for down-converting so as to output the down-converted signal, and the down-converted signal is fed to the baseband processor227 for enabling the baseband processor 227 to output a feedback signal and thus control the compensation unit.

When the combined and down-converted signal is received by the baseband processor 227, the baseband processor 227 will make an evaluation to determine whether the phase-magnitude-compensated signal of the RF signal received from the antenna 205 and the RF signal received from the antenna 207 are optimal. If so, then the baseband processor 227 will keep the current phase and magnitude compensations without changes; if not, then the baseband processor 227 will change the current phase and magnitude compensations by controlling the magnitude compensator 215 and the phase compensator 217 so as to enable the optimization of signal received.

However, the optimization can be accomplished either by the process of the baseband processor 227 along, or by a user through a human-machine-interface to control the baseband processor 227.

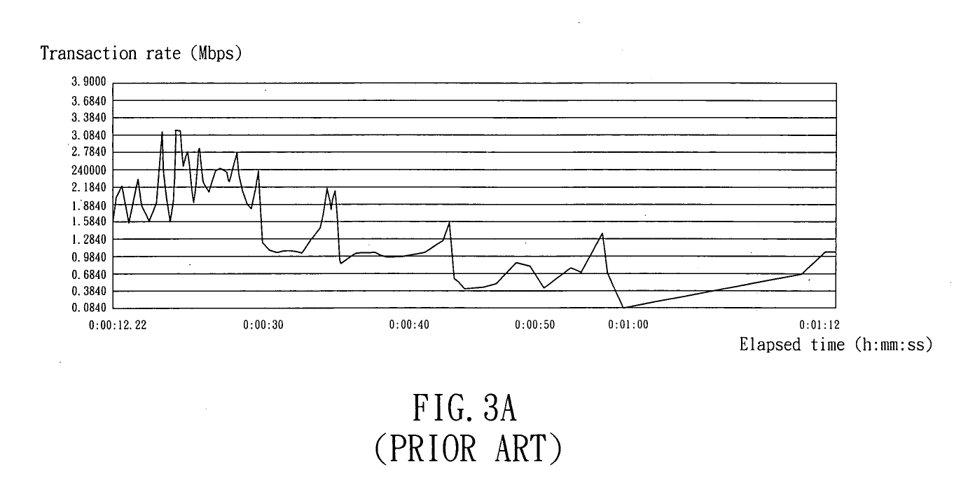

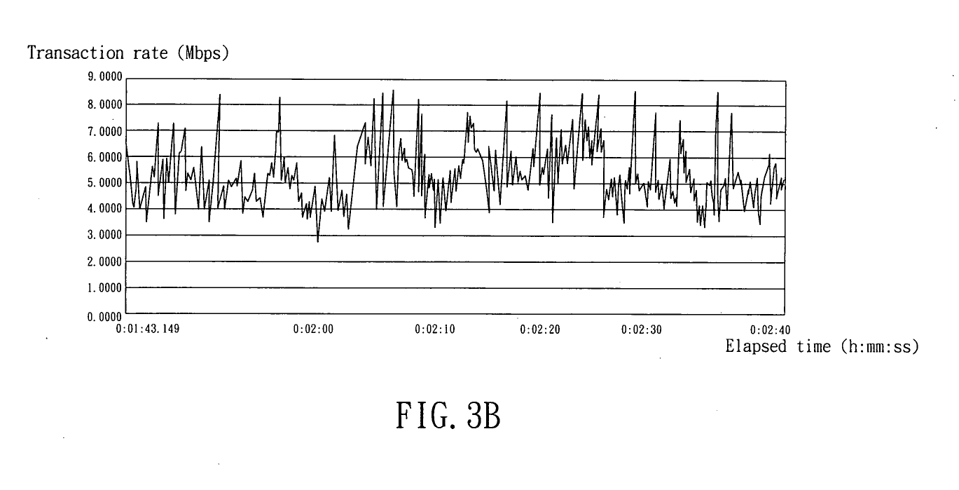

Please refer to FIG. 3A and FIG. 3B, which are diagrams respectively illustrating the transaction rate of a conventional wireless device and a wireless device of the present invention. The profile of the transaction rate of a conventional wireless communication device varies from high to low with great undulation as seen in FIG. 3A. As display by a WLAN linkage configuration program of IEEE 802.11g specification, when the transaction rate is at 1 Mbps, although the quality of linkage is good, but the signal strength is not sufficient. However, the transaction rate of the tunable compensation device for received signals of the invention is maintaining at a speed higher than 3 Mbps as seen in FIG. 3B. Similarly through the same WLAN linkage configuration program of IEEE 802.11g specification, when the transaction rate is at 11 Mbps, the linkage quality and the signal strength of the present invention can still be maintained at a medium range. Obviously, comparing with the prior arts, the present invention not only has better processing efficiency by having faster transaction rate, but also it is capable of maintaining a preferred signal strength while effectively increasing the transaction rate.

In addition, the present invention implements a concept of adjusting the RF signal received by the antenna 207 based on the signal received by another antenna 205 so as to eliminate the inter symbol interference caused by multipath interference. The abovementioned concept is implemented in the present invention not only by using a combined signal of a phase-magnitude-adjusted RF signal received by the antenna 205 and a RF signal received by another antenna 207 for performing the adjustment, but also can be implemented by adjusting the relative positions of the two antennas 205, 207 so as to achieve the same effect as adjusting the RF signal received by the antenna 207 according to the RF signal received by the antenna 205.

To sum up, the present invention provides a tunable compensation device and method for received signals, which involves the use of two antennas to receive two instances of the same signal, wherein a combined signal is formed by synthesizing one instance with another instance which is being compensated, and the combined signal is used as the received signal for enabling the access point/wireless LAN card using the device of the invention to be able to effectively eliminate the inter symbol interference caused by multipath interference.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A tunable compensation device for received signals, comprising:
a first antenna, for receiving a first RF signal and outputting the same;
a compensation unit, coupled to the first antenna for receiving the RF signal outputted from the first antenna and outputting a compensated signal;
a second antenna, for receiving a second RF signal and outputting the same; and
a signal processing unit, for receiving signals outputted from both the compensation unit and the second antenna so as to control the compensation unit to compensate the first RF signal received by the first antenna.

2. The device of claim 1, wherein the compensation unit is a phase compensator, capable of adjusting the phase of the first RF signal outputted from the first antenna and outputting the phase-adjusted signal.

3. The device of claim 1, wherein the compensation unit further comprises:
a magnitude compensator, for receiving the first RF signal and then adjusting the magnitude of the same so as to output a magnitude-adjusted first RF signal
a phase compensator, for receiving the magnitude-adjusted first RF signal and then adjusting the phase of the same so as to output a compensated RF signal

4. The device of claim 1, wherein the signal processing unit further comprises:
a RF combiner, for receiving both the compensated first RF signal outputted from the compensation unit and the second RF signal outputted from the second antenna so as to synthesize the two and then output a combined signal;
a RF front-end, coupled to the RF combiner, for receiving and down-converting the combined signal so as to output a down-converted signal; and
a baseband processor, coupled to both the RF combiner and the RF front-end;
wherein, the down-converted signal is fed to-the baseband processor for enabling the baseband processor to output a feedback signal to the compensation unit for controlling

5. A tunable compensation method for received signals, comprising the steps of:
providing a first antenna and a second antenna for receiving RF signals; and
adjusting the RF signal received by the second antenna based on the RF signal received by the first antenna.

6. The method of claim 5, wherein the method further comprises:
compensating the phase and magnitude of the RF signal received by the first antenna as a compensated RF signal;
combining the compensated RF signal with the RF signal received by the second antenna as a combined RF signal; and
generating a feedback control signal based on the combined signal to feedback control the phase and magnitude compensations of the RF signal received by the first antenna.

7. The method of claim 5, wherein the method further comprises:
down-converting the combined signal to be used as a base for feedback controlling the phase and magnitude compensation of the RF signal received by the first antenna.

8. The method of claim 5, wherein the method further comprises:
adjusting the relative positions of the first antenna and the second antenna for achieving the same effect as adjusting the RF signal received by the second antenna according to the RF signal received by the first antenna.
